(19) United States
(12) Patent Application Publication
(10) Pub. No.: US 2010/0161710 A1
(43) Pub. Date: Jun. 24, 2010

(54) Application services at a terminal

(75) Inventors: Chris Stoner, Hubbardston, MA (US); Andrew Mahon, Arlington, MA (US); Greg Montgomery, SugarHill, GA (US)

Correspondence Address: DITTHAVONG MORI & STEINER, P.C., 918 Prince Street, Alexandria, VA, 22314, US

(73) Assignee: Nokia Corporation

(21) Appl. No.: 12/317,318

(22) Filed: Dec. 22, 2008

(51) Int. Cl. G06F 15/16

(52) U.S. Cl. 709/203

(57) ABSTRACT

An apparatus including: a processor configured to determine whether there is a match between first identifier data received from a remote user terminal and second identifier data, and if there is a match to subsequently acquire and provide application service data to the user terminal; and one or more interfaces configured to receive the first identifier data, the second identifier data and the application service data.

### FIELD OF THE INVENTION

Embodiments of the present invention relate to application services at a terminal. In particular, they relate to methods, apparatus, computer programs for enabling application services at a terminal.

### BACKGROUND TO THE INVENTION

A user of a terminal such as, for example, a mobile cellular telephone, personal digital assistant, personal music player, portable computer, etc., may wish to use the terminal to access applications services such as email provided by a remote server.

It can, however, be a daunting for a user if the user has to manually configure the terminal to access the remote server and to obtain the application service at the terminal.

The terminal may, for example, use a data traffic service provider such as an Internet Service Provider (ISP) or a cellular telephone network operator to communicate. The application service may, for example, only be available to users who have a minimum subscription level with their data traffic service provider.

The complexity of the task for the user may dissuade the user from using the application service at the terminal. However, if the application service were used at the terminal by the user it would provide revenue for the data traffic service provider.

### BRIEF DESCRIPTION OF VARIOUS EMBODIMENTS OF THE INVENTION

According to various embodiments of the invention there may be provided an apparatus comprising: a processor configured to determine whether there is a match between first identifier data received from a remote user terminal and second identifier data, and if there is a match to subsequently acquire and provide application service data to the user terminal; and one or more interfaces configured to receive the first identifier data, the second identifier data and the application service data.

According to various embodiments of the invention there may be provided an apparatus comprising: means for determining whether there is a match between first identifier data received from a remote user terminal and second identifier data; means for subsequently acquiring application service data if there is a match; and means for providing the acquired application service data to the remote user terminal.

According to various embodiments of the invention there may be provided a method comprising: determining whether there is a match between first identifier data received from a remote user terminal and second identifier data; and if there is a match subsequently acquiring and providing application service data to the user terminal.

A computer program which when loaded into a processor enables the processor to:

determine whether there is a match between first identifier data received from a remote user terminal and second identifier data; and

if there is a match, to control acquisition of application service data and to control the provision of the acquired application service data to the user terminal.

According to various embodiments of the invention there may be provided an apparatus comprising: a processor for obtaining identifier data; an output interface configured to send the identifier data to a service hub; and an input interface configured to receive application service data provided by a remote application service provider via the service hub.

According to various embodiments of the invention there may be provided an apparatus comprising:

means for obtaining identifier data;

means for sending the identifier data to a service hub;

means for receiving application service data provided by a remote application service provider via the service hub.

According to various embodiments of the invention there may be provided a computer program which when loaded into a processor enables the processor to: obtain identifier data; control sending the identifier data to a service hub; and process application service data provided by a remote application service provider via the service hub.

A method comprising: storing identifier data on an apparatus configured to send the identifier data to a service hub and to receive application service data provided by a remote application service provider via the service hub; and providing the identifier data to the service hub.

According to various embodiments of the invention there may be provided a system comprising: a plurality of user terminals; a plurality of data traffic service providers that provided data traffic services for the user terminals; a plurality of application service providers that provide application services; and a service hub that enables an applications service to be provided at a data terminal using a data traffic service.

### BRIEF DESCRIPTION OF THE DRAWINGS

For a better understanding of various examples of embodiments of the present invention reference will now be made by way of example only to the accompanying drawings in which:

FIG. 1 schematically illustrates a system comprising a service hub that ensures that each user has access to a correct application service provider;

FIG. 2 schematically illustrates a process that occurs between a data traffic service provider and a service hub;

FIG. 3 schematically illustrates a process that occurs between a user terminal and the service hub;

FIG. 4A schematically illustrates one process that may occur at the service hub;

FIG. 4B schematically illustrates another alternative process that may occur at the service hub;

FIG. 4C schematically illustrates a sub-process of the alternative process;

FIG. 4D schematically illustrates an alternative sub-process of the alternative process;

FIG. 5 schematically illustrates a database at the service hub or accessible by the service hub;

FIG. 6A schematically illustrates a process by which the data transfer service provider may interact with the service hub;

FIG. 6B schematically illustrates a process by which a user terminal may interact with the service hub;

FIG. 7 schematically illustrates how the service hub mediates between an application service provider and a user terminal to provide an application service at the user terminal over the terminal's data traffic service;

FIG. 8 schematically illustrates one implementation of a service hub;

FIG. 9 schematically illustrates one implementation of a terminal; and

FIG. 10 schematically illustrates a delivery mechanism for a computer program.

### DETAILED DESCRIPTION OF VARIOUS EMBODIMENTS OF THE INVENTION

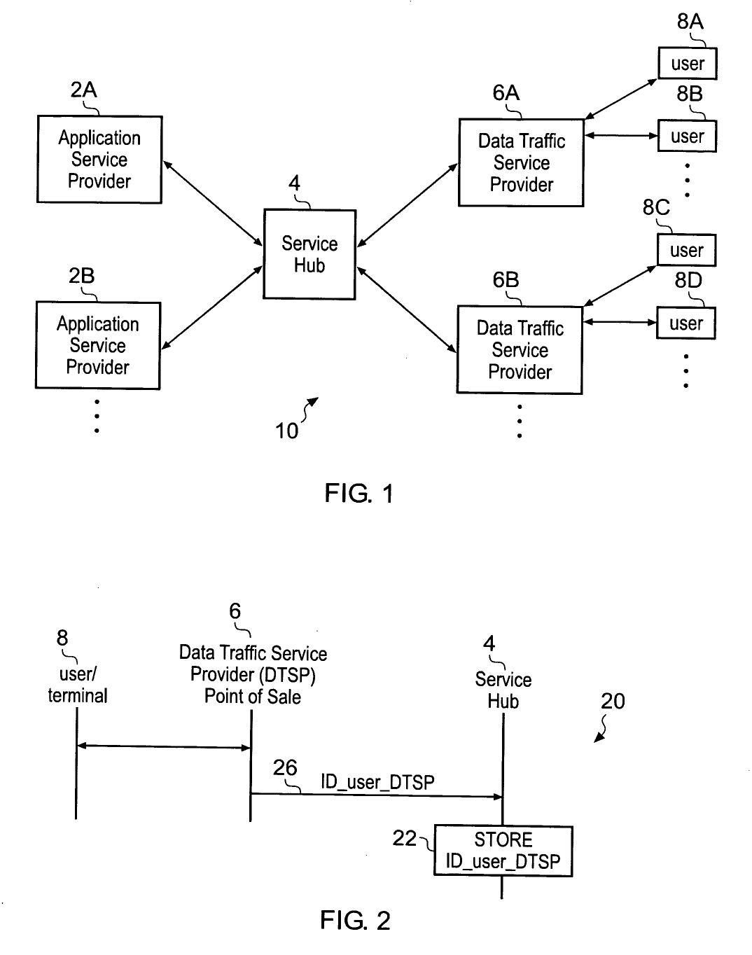

FIG. 1 schematically illustrates a system 10 that comprises: a plurality of application service providers (ASP) 2A, 2B . . . ; a service hub 4; a plurality of data traffic service providers (DTSP) 6A, 6B . . . ; and users 8A 8B, 8C, 8D . . .

Each of the application service providers 2 provides different services and/or different platforms for the same service. Different services may, for example, include email services, concierge services, music download services etc. Different platforms for the same service may, for example, include Gmail, Yahoo etc for email.

Each of the data traffic service providers 6 provides one or more data traffic channels that allow users access to the application service providers. In the illustration, the first DTSP 6A provides access for the users 8A, 8B and the second DTSP 6B provides access for the users 8C, 8D.

The service hub 4 ensures that each user has access to the correct application service provider 2. The service hub 4 mediates access from the many different users 8 who may be using many different DTSPs 6 to many different ASPs 2. It provides a valuable service to the DTSPs 6, as a DTSP need only interface with the service hub 4 to provide its users 8 with access to the large variety of application services provided by the many application service providers to which the service hub 4 interfaces.

FIG. 2 schematically illustrates a process 20 that occurs as a result of interaction between a user 8 and a DTSP 6. This may, for example, occur at a point of sale where a retailer sells a terminal to the user 8 and uses the DTSP's customer management system (CMS) at the point of sale to subscribe the user to a data traffic plan for the DTSP 6. The CMS communicates with the service hub 4 and enables automatic set-up of a mediating service that is provided by the service hub 4.

In the example described below, the user signs up for a particular data traffic plan at the point of sale. This data traffic plan may, for example, entitle the user to particular units of service. The units of service may, for example, be of a general nature such as, for example, the amount of data transferred. The units of service may, however, instead be application service specific such as the amount of data transferred in relation to a particular service application, the time for which a particular service application is available for use, or the time the particular service application can be used for etc.

In the following examples, reference will be made to a messaging service such as an email service, however, it should be appreciated that the invention has broader application to other services.

The user is assigned an identifier ID_user_DTSP 26 by the CMS. The identifier 26 may be a customer or account number or some other identifier such as a mobile telephone number for the user's terminal.

The identifier 26 is then sent automatically to the hub 4 where it is stored 22 in a record 52.

Although the generation and storage of the identifier 26 (ID_user_DTSP) has been described as occurring at the point of sale, it could for example occur prior to sale if the terminal comes with a service pre-paid or it could occur after sale.

Information additional to the identifier 26 may also be sent from the DTSP 6 to the hub 4. The identifier 26 may, for example, be a telephone number for the user's terminal. The additional information may, for example, indicate the level of service that has been subscribed to by the user.

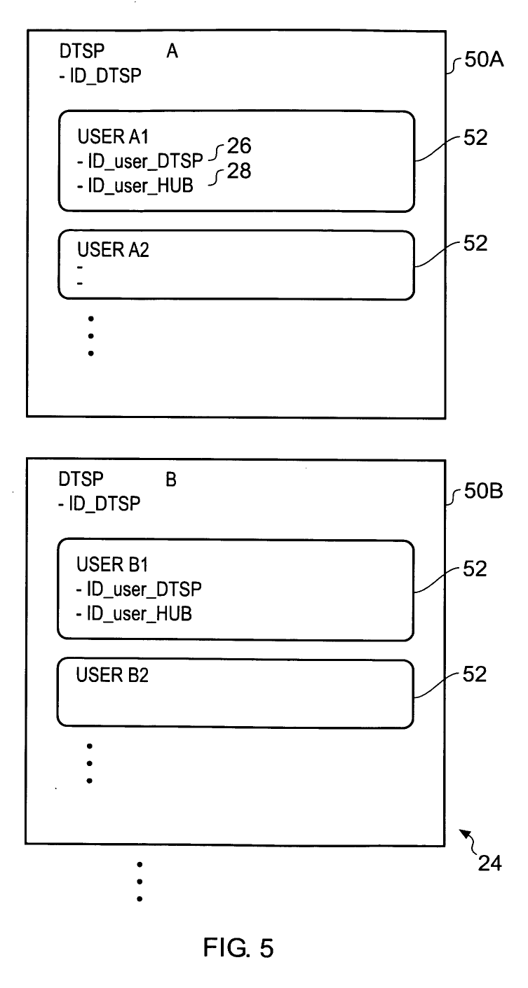

The record 52 is illustrated in more detail in FIG. 5. FIG. 5 schematically illustrates a database 24 at the service hub 4 or accessible by the service hub 4. The database 24 is logically divided into a set 50 of records 52 for each of a plurality of DTSPs. In the illustrated example, there is a first set 50A for DTSP A and a second set 50B for DTSP B. Each of the sets 50 comprises one or more records 52. Each of the records 52 relates to a user. In the illustrated example, a record 50 for a user includes the identifier 26 (ID_user_DTSP) and additional information sent from the CMS of the DTSP 6 to the hub 6 and may also include an identifier or token 28 (ID_user_HUB) used to secure communications between the hub and the terminal of the user 8. The record 50 may indicate service plan or plans already purchased by or on behalf of the user.

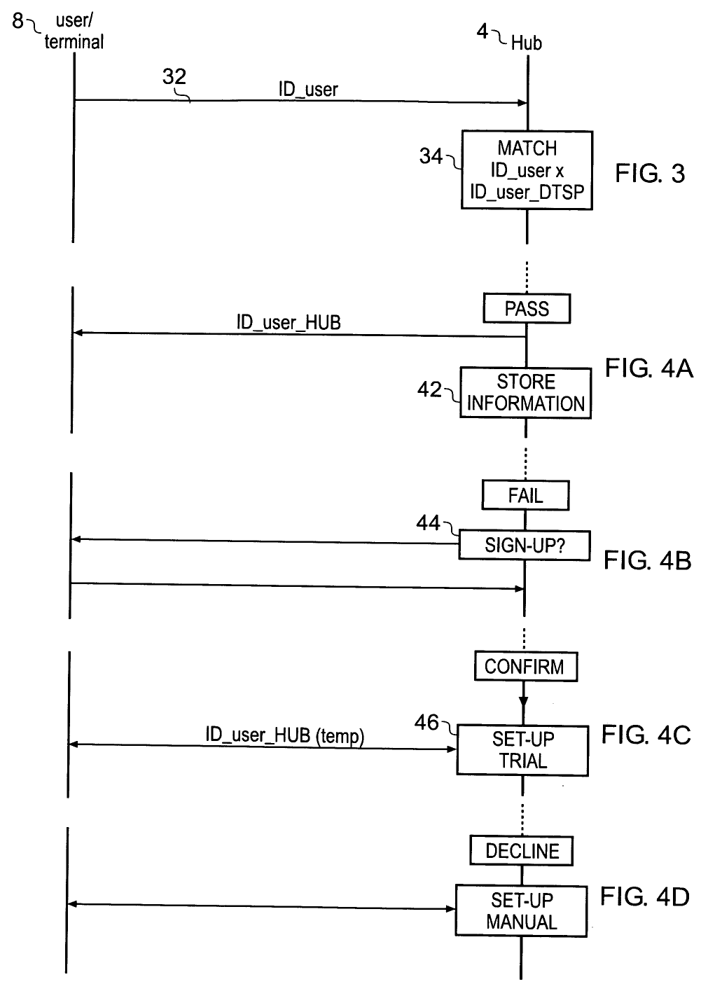

As illustrated in FIG. 3, when the user 8 first turns on the terminal, a wizard is activated. The user may be requested to enter user-specific access information for accessing the email application provided by an unspecified ASP 2. This information may, for example, include an email address and a password.

This information is bundled with information automatically obtained by the user's terminal such as International Mobile Subscriber Identity (IMSI) from a subscriber identity module (SIM), an International Mobile Equipment Identifier (IMEI) from the terminal, telephone number, information identifying the terminal model and version numbers of its software and firmware, and data identifying the DTSP (ID_DTSP) and the country of residence of the user. The information 32 from the user and the terminal is sent preferably in a secure format to the hub 4.

The information 32 conveys an identifier of the user (ID_user). The identifier (ID_user) may identify the user herself or the user's terminal. The identifier 26 may, for example, be a telephone number for the user's terminal.

The hub 4 determines whether the received identifier of the user (ID_user) matches a previously received identifier 26 (ID_user_DTSP).

Referring to the example database illustrated in FIG. 5, the hub may query 34 the database 24 of sets 50 of records 52 using the data identifying the DTSP (ID_DTSP) and the received user identifier (ID_user) to find a matching record. If the database 24 contains a set 50 of records associated with the ID_DTSP and a that set of records contains a record 52 having a user identifier 26 (ID-user_DTSP) that matches the user identifier (user_ID) then the service hub 4 enters a partial ‘pass’ state. If records 50 are not used to indicate service plan or plans or the service plan indicated by the matching record 50 is sufficient for the users service needs then a full ‘pass’ state is entered and an example of the further processing in this state is illustrated in FIG. 4A. If there is no match, the service hub 4 enters a ‘fail’ state and an example of the further processing in this state is illustrated in FIG. 4B.

Referring to FIG. 4A, the service hub 4 in the pass state may create a data element such as an identifier or token 28 (ID_user_HUB) for secure communications between the hub 4 and the terminal of the user 8. The data element 28 (ID_user_HUB) is then stored in the accessed record of the database 24. That is the data element 28 (ID_user_HUB) is stored in the record in the set 50 of records associated with the received ID_DTSP that has a user identifier 26 (ID-user_DTSP) that matches the received user_ID. The data element 28 (ID_user_HUB) is then also sent securely to the user's terminal.

The hub 4 may also send provisioning information such as access point information for the required application service to the terminal which can then use the provisioning information to enable the application service at the terminal.

In the pass state, the information 32 received at the hub 4 from the user and the terminal is stored 42 in the accessed record of the database 24.

The hub 4 may also then charge the DTSP associated with the accessed record a fee for the service provided by the hub 4 in respect of this user.

Referring to FIG. 4B, the service hub 4 in the fail state may run 44 a sign-up routine

that prompts the user terminal to offer to the user a free trial or reduced subscription to one or more data traffic plans for the user's DTSP 6. The DTSP may be determined by communicating with the user's terminal or with a DTSP database.

If the user confirms, the hub 4 enters a ‘confirm trial’ state and an example of the further processing in this state is illustrated in FIG. 4C. If the user declines, the hub 4 enters a ‘decline trial’ state and an example of the further processing in this state is illustrated in FIG. 4D.

In the ‘confirm trial’ state, as illustrated in FIG. 4C, the hub 2 sets-up 46 a trail of the data service.

The hub 4 communicates with the user and terminal to obtain the information 32 from the user and the terminal which is sent preferably in a secure format to the hub 4. This information may include ID_DTSP.

The hub 4 creates a temporary record 52 for the user in the database 24. The record 52 is created in the set 50 of records associated with the received ID_DTSP.

The hub 4 may create a data element such as an identifier or token 28 (ID_user_HUB_temp) for secure communications between the hub 4 and the terminal of the user 8. The data element 28 (ID_user_HUB_temp) is then stored in the created record of the database 24. The data element 28 (ID_user_HUB) is then also sent securely to the user's terminal.

The information 32 received at the hub 4 from the user and the terminal is stored in the created record of the database 24.

The hub 4 may also then charge the DTSP associated with the record a fee for the service provided by the hub 4 in respect of this user.

After a predetermined number of units of data traffic service by the hub 4 for the user, the temporary record 52 is deleted. Before deletion, the user may be offered the opportunity to subscribe to a traffic data service.

In the ‘decline trial’ state, as illustrated in FIG. 4D, the hub 2 prompts the terminal to run a routine that helps the user set up an alternate service such as one where the user accesses the ASP directly on an ad-hoc basis to pull application service data from the ASP.

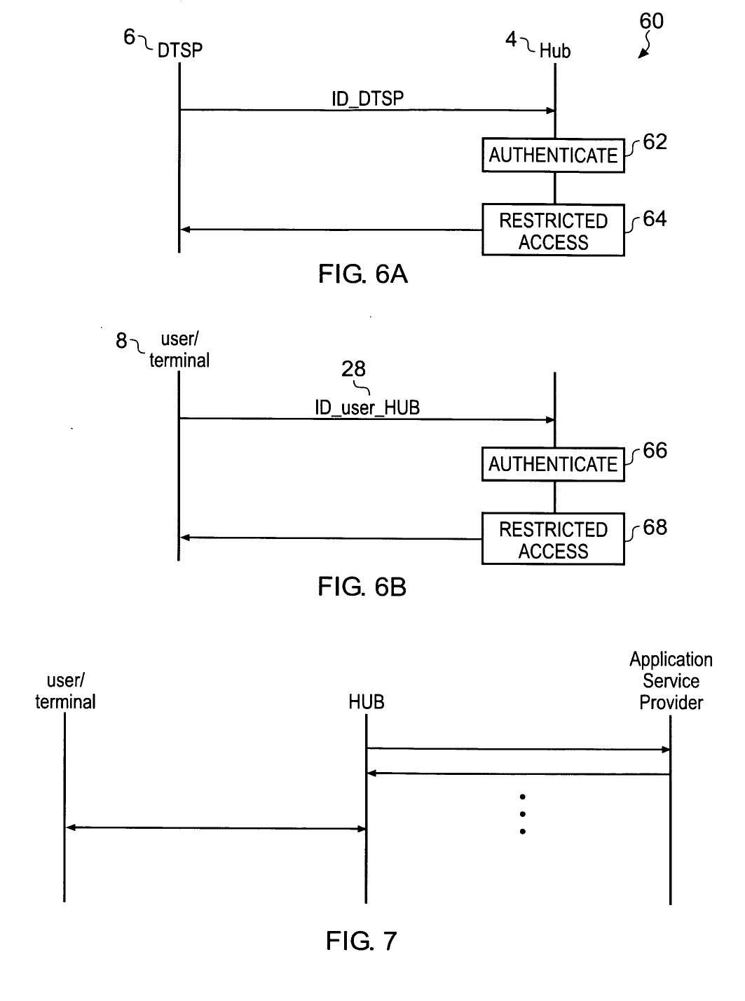

FIG. 6A schematically illustrates a process by which the DTSP 6 may interact with the hub 4. The DTSP 6 identifies itself to the hub 4, for example, using the DTSP identifier ID_DTSP. Typically the communication will be secure and will enable the hub to verify the identity of the DTSP 6.

At block 62, the hub 4 performs an authentication process. There are various processes known in the art. In one implementation, the ID_DTSP or a HASH of the ID_DTSP may be encoded using a private certificate of the DTSP. The hub then uses a public certificate of the DTSP to decode the encoded data and to verify that the decoded data matches the expected data (the ID_DTSP or its HASH).

At block 64, the hub 4 enables access to only the set 50 of records that are associated with the authenticated DTSP. The DTSP may have read and/or write access to the record 52 of a user within its set 50.

The hub 4 may also then charge the DTSP a fee for the access service.

FIG. 6B schematically illustrates a process by which a user 8 may interact with the hub 4. The user 8 identifies itself to the hub 4, for example, using the data element 28. Typically the communication will be secure and will enable the hub to verify the identity of the DTSP 6.

At block 66, the hub 4 performs an authentication process. There are various processes known in the art. In one implementation, the data element 28 or a HASH of the data element may be encoded using a secret shared between the user and the hub 4. The hub 4 then uses the shared secret to decode the encoded data and to verify that the decoded data matches the expected data (the data element or its HASH).

At block 68, the hub 4 enables access to only the records that are associated with that data element 28. The user may have read and/or write access to only certain parts of the record and may, for example, be able to upgrade their current data plan.

The hub 4 may also then charge the DTSP associated with the record a fee for this service.

FIG. 7 schematically illustrates how the hub 4 mediates between an ASP 2 and a user 6.

The hub 4 uses the data traffic service provided by the DTSP 6 for which a user 8 has a data plan. The hub 4 automatically communicates with the ASP 2 to pull application service data for the user from the ASP 2.

The hub 4 collates and processes the application service data for the user and then pushes application service data to the user 8 via the appropriate DTSP for the user. The data transfer may me metered against an account for the user.

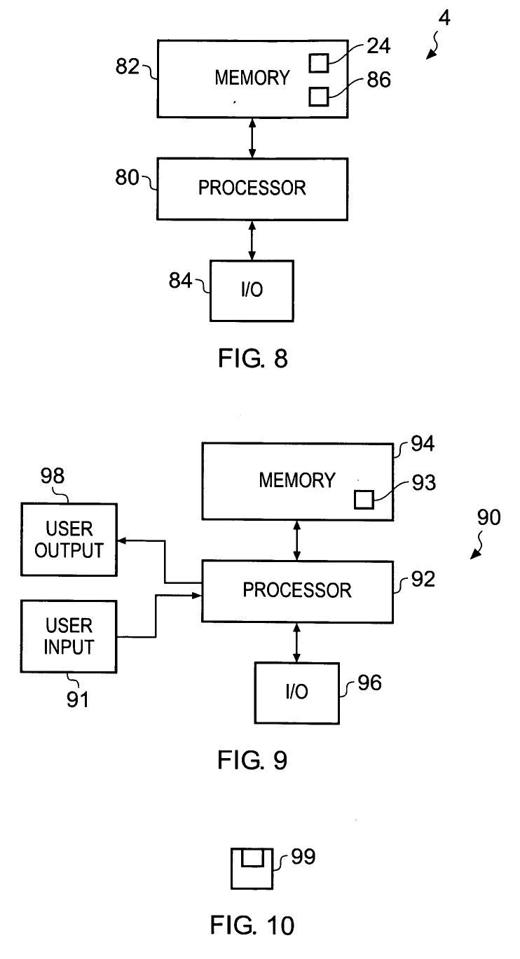

FIG. 8 schematically illustrates one implementation of a service hub 4. The service hub 4 is configured in this example as a controller or computer apparatus having a processor 80, an input/output interface 84 and a memory 82. It may operate as a web-server.

Implementation of the apparatus 4 can be in hardware alone (a circuit, a processor . . . ), have certain aspects in software including firmware alone or can be a combination of hardware and software (including firmware).

The processor 80 is configured to read from and write to the memory 82. The processor is configured to receive data from and provide data to the input/output interface 84. The input/output interface is configured to communicate with data communication infrastructure that enables communication with the ASPs 2 and the users 8.

The processor 80 is operationally coupled to the memory 82 and to the input/output interface 84 and any number or combination of intervening elements can exist (including no intervening elements)

The memory 82 may store the database 24 such as, for example, described with reference to FIG. 5. The memory 82 may also store a computer program 86 comprising computer program instructions that control the operation of the service hub 4 when loaded into the processor 80. The computer program instructions provide the logic and routines that enables the apparatus to perform the methods illustrated in the Figures. The processor 80 by reading the memory 82 is able to load and execute the computer program 86.

The computer program may arrive at the service hub 4 via any suitable delivery mechanism 99 (FIG. 10). The delivery mechanism 99 may be, for example, a computer-readable storage medium, a computer program product, a memory device, a record medium such as a CD-ROM or DVD, an article of manufacture that tangibly embodies the computer program 86. The delivery mechanism may be a signal configured to reliably transfer the computer program 86. The apparatus 4 may propagate or transmit the computer program 86 as a computer data signal.

Although the memory 82 is illustrated as a single component it may be implemented as one or more separate components some or all of which may be integrated/removable and/or may provide permanent/semi-permanent/dynamic/cached storage.

FIG. 9 schematically illustrates one implementation of a terminal apparatus 90 for use by a user.

Implementation of the terminal 90 can be in hardware alone (a circuit, a processor . . . ), have certain aspects in software including firmware alone or can be a combination of hardware and software (including firmware).

In the illustrated example, the terminal 90 is configured as a computer having a processor 92, an input/output interface 96 such as a cellular radio transceiver, a memory 82, a user output device 98 for providing information to a user such as a display and a user input device 91 for receiving commands from a user such as a keypad.

The processor 92 is operationally coupled to the memory 94, to the input/output interface 96, to the user output device 98, and to the user input device 91 and any number or combination of intervening elements can exist (including no intervening elements)

The processor 92 is configured to read from and write to the memory 94. The processor 92 is configured to receive data from and provide data to the input/output interface 96. The input/output interface 96 is configured to communicate with data communication infrastructure that enables communication with the service hub 4. The processor 92 is configured to receive input commands from the user input device 91 and provide output commands to the user output device 98.

The memory 94 may store a computer program 93 comprising computer program instructions that control the operation of the apparatus 90 when loaded into the processor 92. The computer program instructions provide the logic and routines that enables the apparatus 90 to perform the methods illustrated in the Figures. The processor 92 by reading the memory 94 is able to load and execute the computer program 93.

The computer program 93 may arrive at the terminal apparatus 90 via any suitable delivery mechanism 99 (FIG. 10). The delivery mechanism 99 may be, for example, a computer-readable storage medium, a computer program product, a memory device, a record medium such as a CD-ROM or DVD, an article of manufacture that tangibly embodies the computer program 86. The delivery mechanism may be a signal configured to reliably transfer the computer program 86. The apparatus 90 may propagate or transmit the computer program 93 as a computer data signal.

Although the memory 94 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The blocks illustrated in the illustrated methods may represent steps in a method and/or sections of code in the computer program. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising:
a processor configured to determine whether there is a match between first identifier data received from a remote user terminal and second identifier data, and if there is a match to subsequently acquire and provide application service data to the user terminal; and
one or more interfaces configured to receive the first identifier data, the second identifier data and the application service data.

2. An apparatus as claimed in claim 1, wherein the second identifier data originates from a data traffic service provider that provides a data traffic service to the user terminal.

3. An apparatus as claimed in claim 1, further comprising a memory for storing the second identifier data.

4. An apparatus as claimed in claim 1, wherein the apparatus is configured to acquire and provide application service data from an application service provider.

5. An apparatus as claimed in claim 1, wherein the apparatus is configured to acquire and provide different application service data from different application service providers and provide the acquired application service data to respective ones of a plurality of user terminals using a plurality of data traffic services.

6. An apparatus as claimed in claim 1, further comprising a memory for storing application service data.

7. An apparatus as claimed in claim 1, further comprising a database that associates each user terminal with at least one of a plurality of application service providers and one of a plurality of traffic data service providers.

8. An apparatus as claimed in claim 1, wherein the processor is configured, if there is a match, to provide provisioning data to the user terminal for enabling an application service at the user terminal.

9. A method comprising:
determining whether there is a match between first identifier data received from a remote user terminal and second identifier data; and
if there is a match subsequently acquiring and providing application service data to the user terminal.

10. A method as claimed in claim 9, wherein the second identifier data originates from a data traffic service provider that provides a data traffic service to the user terminal.

11. A method as claimed in claim 9, wherein the application service data is acquired from an application service provider.

12. A method as claimed in claim 9, comprising: associating each user terminal with at least one of a plurality of application service providers and one of a plurality of traffic data service providers; and
for each user terminal, acquiring application service data from the application service provider associated with the user terminal and providing the acquired application service data to user terminal using the data traffic service associated with the user terminal.

13. A method as claimed in claim 9, comprising: associating each user if there is a match to provide provisioning data to the user terminal for enabling an application service at the user terminal

14. An apparatus comprising:
a processor for obtaining identifier data;
an output interface configured to send the identifier data to a service hub; and
an input interface configured to receive application service data provided by a remote application service provider via the service hub.

15. An apparatus as claimed in claim 14, wherein the identifier data is provided by a data traffic service provider that provides a data traffic service for the apparatus.

16. An apparatus as claimed in claim 14 wherein the processor is configured to obtain the identifier data from storage in a memory of the apparatus and to control sending the identifier data to the service hub.

17. A system comprising:
a plurality of user terminals;
a plurality of data traffic service providers that provided data traffic services for the user terminals;
a plurality of application service providers that provide application services; and
a service hub that enables an applications service to be provided at a data terminal using a data traffic service.

18. A system as claimed in claim 17 comprising:
a database associating each user terminal with at least one of the plurality of application service providers and one of the plurality of traffic data service providers;

19. A system as claimed in claim 17, wherein the service hub is configured to acquire application service data from an application service provider associated with a user terminal and provide the acquired application service data to said user terminal using the data traffic service associated with said user terminal.
